(19) United States
(12) Patent Application Publication
(10) Pub. No.: US 2012/0086691 A1
(43) Pub. Date: Apr. 12, 2012

(54) ELECTROFLUIDIC CHROMATOPHORE (EFC) DISPLAY APPARATUS

(75) Inventors: Petrus Johannes Gerardus van Lieshout, Eindhoven (NL); Hjalmar Edzer Ayco Huitema, Eindhoven (NL)

(73) Assignee: Polymer Vision B.V., Eindhoven (NL)

(21) Appl. No.: 12/899,081

(22) Filed: Oct. 6, 2010

(51) Int. Cl. G09G 5/00; G09G 3/22

(52) U.S. Cl. 345/211; 345/60

(57) ABSTRACT

A display apparatus is described that includes a plurality of electrofluidic chromatophore (EFC) pixel cells. Each pixel cell comprises a fluid holder for holding a polar fluid and a non-polar fluid having differing display properties, the fluid holder comprising a reservoir with a geometry having a small visible area projected in the direction of a viewer onto the polar fluid, and a channel with a geometry having a large visible area projected in the direction of a viewer onto the polar fluid. The channel is connected to the reservoir so as to enable free movement of the polar fluid and non-polar fluid between the channel and the reservoir. At least part of a surface of the channel comprises a wetting property responsive to a supply voltage over the pixel cell and defining (i) a stable region wherein the supply voltage stabilizes polar fluid in the channel; (ii) a fill region that controls filling of polar fluid in the channel and (iii) a retract region that controls retracting of polar fluid in the channel. At least two pixel cell terminals are configured to supply the supply voltage to at least part of the surface of the channel comprising the wetting property for supply voltage controlled channel movement of polar fluid. The display further comprises a driver operative to provide controlled column voltages and any of a predefined row select or non-select voltage. A circuit board comprises a row electrode and a column electrode each directly connecting the driver to the pixel cell terminals for supplying the supply voltage to the pixel cell terminals as a voltage difference between the row and column electrodes in a passive matrix configuration.

### TECHNICAL FIELD

The invention relates to the field of displays, in particular, displays comprising electrofluidic cells.

### BACKGROUND

Up to now, in certain areas of display technology, an electrophoretic electro-optical medium is commonly used, in particular for flexible displays. However, the electrophoretic electro-optical medium is subject to a number of restrictions. The medium has a relatively slow pixel response that makes video display challenging and has a relatively low brightness compared to paper.

Displays based on the electrowetting electro-optical medium may remedy at least some of the restrictions mentioned above. Particular variants using this principle are e.g. described in publications WO2004068208 and U.S. Pat. No. 4,583,824. These variants have a height dimension that is relatively large compared to liquid crystal or electrophoretic displays which hinders the use in flexible displays.

### SUMMARY OF THE INVENTION

The recently developed Electrofluidic Chromatophore (EFC) variant of a display based on electrowetting has a smaller height dimension and may therefore be more suitable to use in flexible displays.

Because pixels in displays based on the EFC technology have a high reflectivity, these displays can be used in situations ranging from dim ambient lighting to full sun-light.

In the remainder, we will refer to an EFC cell as a pixel cell comprising a fluid holder for holding a polar fluid and a non-polar fluid having differing display properties, the fluid holder comprising a reservoir with a geometry having a small visible area projected in the direction of a viewer, and a channel with a geometry having a large visible area projected in the direction of a viewer, the channel being connected to the reservoir so as to enable free movement of the polar fluid and non-polar fluid between the channel and the reservoir, at least part of a surface of the channel comprising a wetting property responsive to a supply voltage over the pixel cell and defining (i) a stable region wherein the supply voltage stabilizes the amount of polar fluid in the channel; (ii) a fill region that controls the flow of polar fluid into the channel and (iii) a retract region that controls the flow of polar fluid into the reservoir; and at least two pixel cell terminals being configured to supply the supply voltage to at least part of the surface of the fluid holder comprising the wetting property for supply voltage controlled movement of polar fluid.

The EFC pixel cell will respond in dependency of the supplied voltages, in particular, the fill or retract level of the polar fluid will be controlled. The various conditions that the EFC cell can exhibit as a result of these controlled voltages may in the remainder be also referred to as cell display properties or cell states, more particular, a fill state, retract state or stable state, to correspond to the visual appearance a black state, white state or more generally a color state that can be stable or change dependent on the supply voltage.

The state of an EFC cell is not directly related to the voltages at the terminals. Instead, these voltages and their timing control the rate and direction of change of the state. Therefore, to drive a cell to a certain state, differential driving is needed, i.e. driving that takes into account the current state of the cell and applies certain voltages at the cell terminals for a certain time to reach the new, wanted state. Actual voltage levels can be influenced by cell geometry and material properties. In previous applications, an active matrix design has been proposed including pixel-based active elements to provide the required driving signals to the EFC pixel. Due to the complex composition and needed materials for such an active matrix design a desire exists to provide a driving system that has lowered manufacturing costs and still provides acceptable display functionality. It is also an object of this invention to propose an EFC display drive scheme to display content in an energy efficient manner.

According to an aspect of the invention, there is provided a display apparatus comprising a plurality of electrofluidic chromatophore (EFC) pixel cells. Each pixel cell comprises a fluid holder for holding a polar fluid and a non-polar fluid having differing display properties, the fluid holder comprising a reservoir with a geometry having a small visible area projected in the direction of a viewer, and a channel with a geometry having a large visible area projected in the direction of a viewer. The channel is connected to the reservoir so as to enable free movement of the polar fluid and non-polar fluid between the channel and the reservoir. At least part of a surface of the channel comprises a wetting property responsive to a supply voltage over the pixel cell and defining (i) a stable region wherein the supply voltage stabilizes the amount of polar fluid in the channel; (ii) a fill region wherein the amount of polar fluid in the channel increases and (iii) a retract region wherein the amount of polar fluid in the channel decreases. At least two pixel cell terminals are configured to supply the supply voltage to at least part of the surface of the channel comprising the wetting property for supply voltage controlled channel movement of the polar—non-polar fluid front. The display further comprises a driver operative to provide controlled column voltages and any of a predefined row select or non-select voltage via respective column and row electrodes. A circuit board comprises a row electrode and a column electrode each directly connecting the driver to the pixel cell terminals for supplying the supply voltage to the pixel cell terminals as a voltage difference between the row and column electrodes in a passive matrix configuration. Passive-matrix displays typically have no pixel wise active elements such as transistors and are thus simpler in construction than active-matrix displays. Because of this, passive-matrix displays can be fabricated at lower cost and higher yield than active-matrix displays.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 shows a schematic configuration of an embodiment of the display apparatus;

FIG. 2 shows a top view of an embodiment of an electrofluidic pixel cell in the embodiment of FIG. 1;

FIG. 3 shows a cross sectional side view of the electrofluidic pixel cell of FIG. 2;

FIG. 4 shows various schematic connections for connecting the electrofluidic pixel cell to a matrix electrode structure;

FIG. 5 shows a schematic chart of the water front velocity (v) in the pixel channel as a function of the supply voltage (V);

FIG. 6 shows an abstracted line chart of FIG. 5;

FIG. 7 shows a schematic passive matrix arrangement for a plurality of pixel cells;

FIG. 8 shows a first embodiment of a driving method for a passive matrix;

FIG. 9 shows a special case of the first embodiment;

FIG. 10 shows a second embodiment of a driving method for a passive matrix;

FIG. 11 shows a third embodiment of a driving method for a passive matrix;

FIG. 12 shows a fourth embodiment of a driving method for a passive matrix;

FIG. 13 shows a special case of the fourth embodiment of a driving method for a passive matrix;

FIG. 14 shows abstracted line charts wherein a various bias voltages are applied to the pixel cell;

FIG. 15 shows a fifth embodiment of driving method for a passive matrix including a bias voltage; and

FIG. 16 shows a sixth embodiment of driving method for a passive matrix including a bias voltage.

### DETAILED DESCRIPTION OF THE DRAWINGS

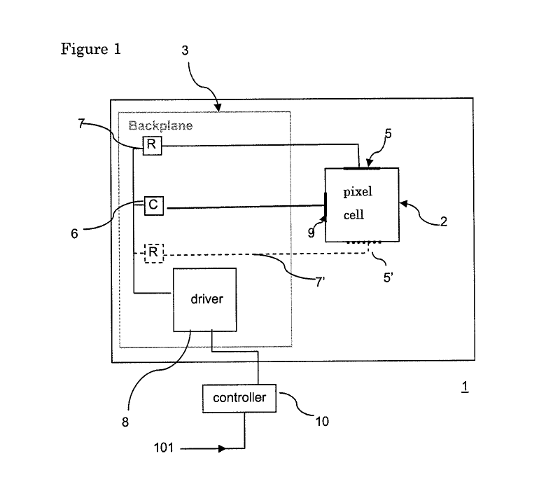

FIG. 1 shows a schematic configuration of an embodiment of the display apparatus. Besides a plurality of pixel cells 2, the display apparatus 1 further comprises a flexible circuit board 3, in the art also referenced as backplane and preferably bendable with a small radius for example smaller than 2 cm—so that the display can be rolled, flexed or wrapped in a suitably arranged housing structure. The circuit board 3 comprises a plurality of row electrodes and column electrodes for supplying an electrical charge to the pixel cells 2. It may however also be possible that more electrodes are connected to the pixel cell 2, depending on the specific implementation. A driver 8 is configured to charge the row 7 and column electrodes 6 to address a supply voltage to the pixel cells 2. The driver 8 may be incorporated in the circuit board 3 or any other convenient place.

A display controller 10 is arranged to control the driver 8 as a result of pixel image information 101 inputted in the display controller 10. Typically, the display 1 is refreshed a number of times per second. The frame time is defined as the time wherein all the pixels of a display are refreshed once. The frame time comprises a line selection time, wherein the pixel cells 2 connected to a row 7 are activated, followed by a hold time, wherein the other rows are sequentially addressed. Alternatively other update schemes may be provided, e.g. with multiple row addressing, where more than one row is selected and refreshed at a time.

In the following, the operation of the present EFC pixel cell is further explained. Amongst others, it will be shown that there is a stable supply voltage that stops the polar—non-polar fluid front movement in the channel of a pixel cell.

As shown in the picture, circuit board 3 comprises a row electrode and a column electrode each directly connecting the driver 8 to the pixel cell terminals 5, 5′, and 9 for supplying the supply voltage to the pixel cell terminals as a voltage difference between the row and column electrodes in a passive matrix configuration.

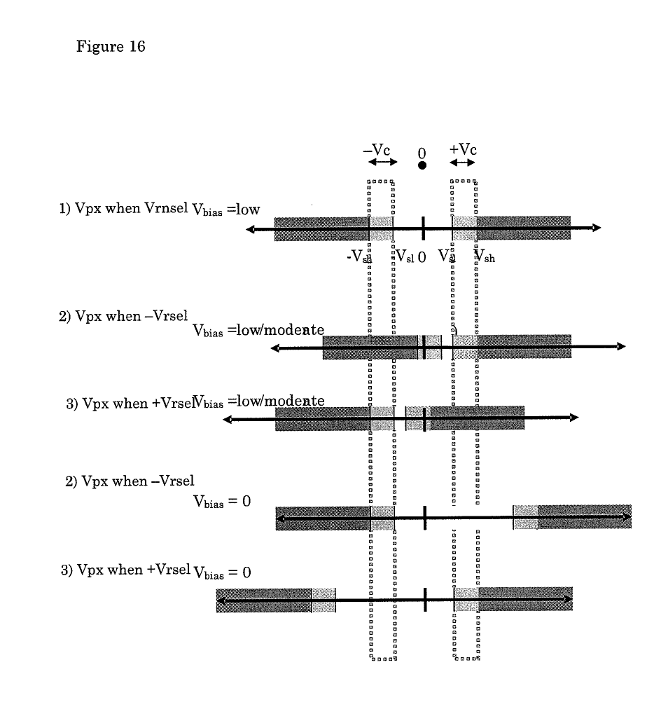

While a supply voltage can be typically supplied to a pixel cell 2 via a single row and column electrode 6, 7, pixel cell 2 can be additionally connected with another row electrode 5′, typically, having a further pixel cell terminal that is electrically connected to a further electrode 5′ directly connected to the driver 8 to provide a bias supply voltage or basic supply voltage to the pixel cell as will be explained hereafter. The additional bias electrode can be provided as a patterned electrode parallel to the row electrodes. In such an arrangement a pixel cell intermediate condition can be provided. This condition can be defined as a state of the pixel cell wherein the possible cell display property changes are limited due to the supply of a basic supply voltage to the at least one further pixel cell terminal with the aim to reduce the column voltage required to induce a change in the cell display property. The bias voltage may be dependent on the display property change. The effects of bias voltage are further discussed with reference to FIG. 16. The switching circuit typically has row and column electrodes 6, 7 respectively that connect the switching circuit to the driver 8, although it is also possible that more or less electrodes are used depending on the specific implementation of the switching circuit.

The switching state of an electrofluidic pixel cell 2 is not directly related to the voltages at the terminals 5, 9. Instead, these voltages and their timing control the rate and direction of change of the switching state. Therefore, to drive a cell to a certain switching state, differential driving is needed, i.e. driving that takes into account the current switching state of the cell 2 and applies certain voltages at the cell terminals 5, 9 for a certain time to reach the new desired switching state. One possibility is that a copy of the currently displayed image is kept and used in the calculation of the driving signals for the new image. Another option is to reset the entire display to a known switching state, e.g. the state in which all cells 2 are fully retracted, (in the absence of supply voltage) and apply certain driving signals by driver 8 to display a new image.

Advantageously, this passive matrix configuration can be used for applications with a relatively low information change rate, like e-reading, map navigation, camouflage skinning, (outdoor) signage, shelf-edge labeling etc.

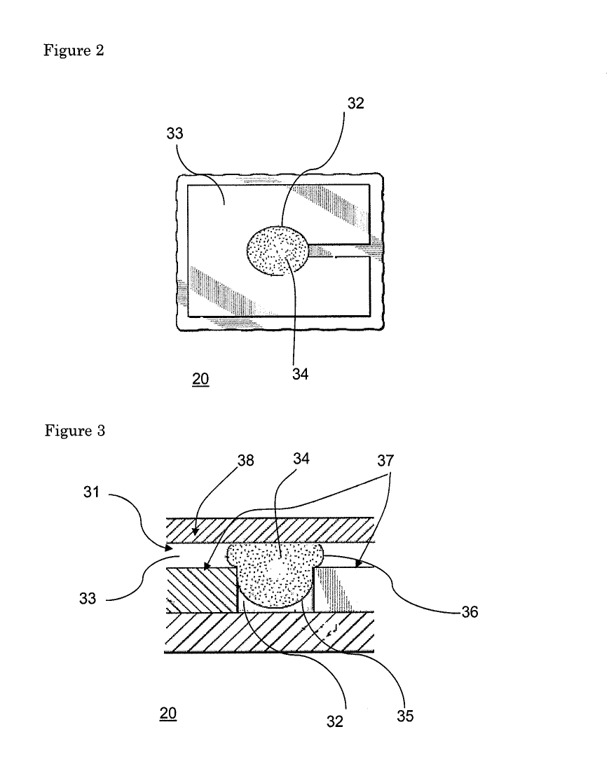

FIG. 2 shows a top view of the electrofluidic pixel cell shown in cross sectional view in FIG. 3. It may be seen that the geometry of fluid reservoir 32 imparts a small visible area projected in the direction of a viewer and the geometry of the channel 33 imparts a large visible area projected in the direction of a viewer. To create a black state, the blackened water occupies the channel 33 and the clear oil occupies the fluid reservoir 32. In the white state, the clear oil occupies the channel 33 and the blackened water occupies the reservoir 32. By varying the amount of black water and clear oil in the channel 33, various cell display properties, also named color states, may be created. Instead of black water any suitably colored or clear polar fluid may be used; instead of clear oil any suitably colored or clear non-polar fluid may be used, as long the two fluids are sufficiently immiscible.

A color display variant may be implemented by using water of different colors for different pixel cells, for example red, green and blue or cyan, magenta and yellow, or by providing a color filter on top of a black and white display or by integrating the color filter in the display on or near the top surface 38 of the channel 33.

The channel 33 is typically 3 to 5 um in height; the thickness of the mesa defining the lower channel wall 37 is typically 40 um. The theoretical switching speed is in the order of milliseconds for both transitions.

FIG. 3 shows a fluid holder 31 of pixel cell 2 (FIG. 1) in cross sectional view. The fluid holder comprises a fluid reservoir 32 with a small visible area projected in the direction of a viewer and a channel 33 with a large visible area projected in the direction of a viewer. The fluid reservoir 32 and the channel 33 are connected so as to enable free movement of the polar fluid 34 between the channel 33 and the fluid reservoir 32.

Typically, besides a polar fluid 34, the fluid holder 31 also comprises a non-polar fluid (not shown). To generate a cell display property, the polar fluid 34 and the non-polar fluid have differing display properties. A display property may e.g. be a color, also encompassing monochromatic variants or a certain transmission and/or reflection characteristic of the fluid. In one embodiment, the polar fluid 34 has a transmission differing from the non-polar fluid. Typically, the polar fluid 34 comprises water and the non-polar fluid comprises oil. Preferably the water is blackened and the oil is left clear or is diffuse scattering, because blackening water with pigments may yield a more saturated black than blackening oil with dyes. Pigmented blackened water may result in a sufficiently black pixel color with a layer of water with a thickness of only 3 micrometer. This allows a display with a total thickness less than 100 micrometer, which typically is within a suitable thickness range for flexible displays. Typically the water contains ionic content as the conductive element. The non-polar fluid may occupy the space not occupied by the polar fluid 34. The non-polar fluid is preferably immiscible with the polar fluid 34.

In an embodiment, the geometry of the channel 33 and the fluid reservoir 32 are carefully constructed to impart a mutually differing principle radius of curvature. In such embodiments, the fluid reservoir 32 imparts a large principle radius 35 of curvature onto the polar fluid and the channel imparts a small principle radius 36 of curvature onto the polar fluid 34 when the surfaces of the channel 33 and the fluid reservoir 32 are sufficiently hydrophobic. This configuration results in a Young-Laplace force that aims to bring the polar fluid in its energetically most favorable shape, i.e. the droplet shape and urges the polar fluid 34 into the fluid reservoir 32.

On the other hand, however, the polar fluid 34 may be urged into the channel 33 by generating an electromechanical force larger than and opposite of the Young-Laplace force. To control this force, at least part of a surface 38 of the channel 33 and the lower channel wall 37 comprises a wetting property responsive to an applied supply voltage to one or more of the walls of the fluid holder 31. The polar fluid 34 may comprise a conductive element or component. Typically a hydrophobic fluoropolymer is provided on at least part of the surface 38 of the channel 33 and the lower channel wall 37, although other materials having a wetting property responsive to an electric field may be applied.

The electromechanical force is directed opposite to the counteracting force that urges the polar fluid 34 into the fluid reservoir 32 and may be controlled by varying the supply voltage. This counteracting force may be the Young-Laplace force or another, oppositely directed, electromechanical force or a combination of those.

A supply voltage providing a balance of counteracting force and electromechanical force, i.e. a voltage whereby movement of the polar fluid 34 is absent is called the stable voltage. Although the stable voltage may show variation depending on the cell display property, it is in principle unrelated to the cell display property. That is, substantially independent of the fluid front position, the stable voltage will stabilize the fluid front of the polar fluid 34. It is noted that this characteristic may not be found in other display types like electrophoretic or liquid crystal displays. In other words, providing the stable supply voltage to a pixel cell stabilizes the polar fluid 34 in the pixel cell 20.

By applying a supply voltage to at least a part of the channel surface 37, 38 of the channel 33, the induced electric field typically reduces the hydrophobic character of the fluoropolymer and results in an electromechanical force, aiming to bring the polar fluid 34 from the reservoir 32 into the channel 33 that is proportional to the supply voltage over the at least part of the channel surface 37, 38 squared. The supply voltage changes the wetting property of at least part of the surface 37, 38 of the channel 33.

Varying the electromechanical force may be used to control the movement of the polar fluid 34 in the pixel cell 20. Therefore, the pixel cell 20 comprises at least two pixel cell terminals (not shown). The pixel cell terminals are arranged to apply a supply voltage via electrodes (not shown) to the at least part of the surface of the channel 33 comprising the wetting property responsive to an applied supply voltage. The supply voltage may be provided by a combination of voltage differences, from any of a number of electrodes attached to the pixel cell.

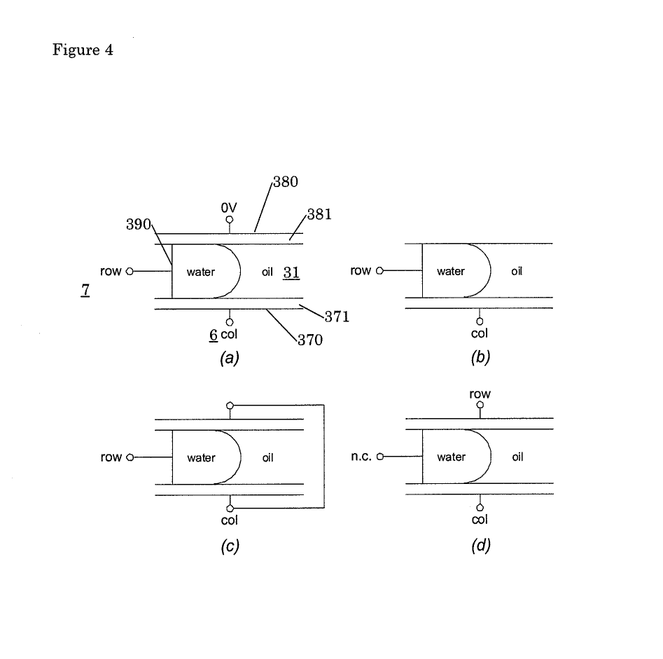

FIG. 4 a-d shows various schematic connections for connecting the electrofluidic pixel cell to a matrix electrode structure in a 3-terminal configuration. At the top and bottom of the channel, there are planar electrodes 380, 370 covered by dielectric layer 371, 381. The polar water droplet forms the third electrode 390. Alternatively, the top electrode can be left out. Care has to be taken that the wetting properties of the top wall of the channel 31 are optimized in this case. For reading convenience the reference numerals are only indicated in FIG. 4a.

Electromechanical force on the water-oil front is caused by a voltage across a dielectric stack including the fluoropolymer layer. In passive-matrix configuration, there are row and column electrodes, with a pixel at each crossing.

In more detail, the configuration of FIG. 4 (a) shows a common terminal being connected to a common electrode for a group of pixels or all pixels in the display. This electrode can alternatively or additionally provide a bias voltage as discussed herein below. In some embodiments as illustrated by the configurations of FIG. 4 (b) a patterned top electrode 380 is not needed, which is an advantage because it allows for much simpler manufacturing. A galvanic connection to the water is provided for water electrode 390. Because the driving forces have to be generated by the dielectric interface on the lower wall 37, the supplied voltages are relatively high. The configuration of FIGS. 4 (c) and (d) comprise a patterned top electrode 380 that is electrically connected to a column driver or row driver, in addition to a patterned bottom electrode 370. The supply voltages are lower because both dielectric interfaces to the water are used to generate the electromechanical force. In FIG. 4 (d), the water electrode 390 can be dispensed with so that the column voltage terminal 6 is coupled only to a channel electrode 370 on a side facing away from a direction of the viewer, which might be an advantage for robustness to dielectric pinholes. In the FIG. 4 a-c embodiments, the row electrode 7 is coupled to a contact electrode contacting the conductive polar fluid. In the embodiment shown in FIG. 4d the row electrode 7 is coupled to a channel electrode 370.

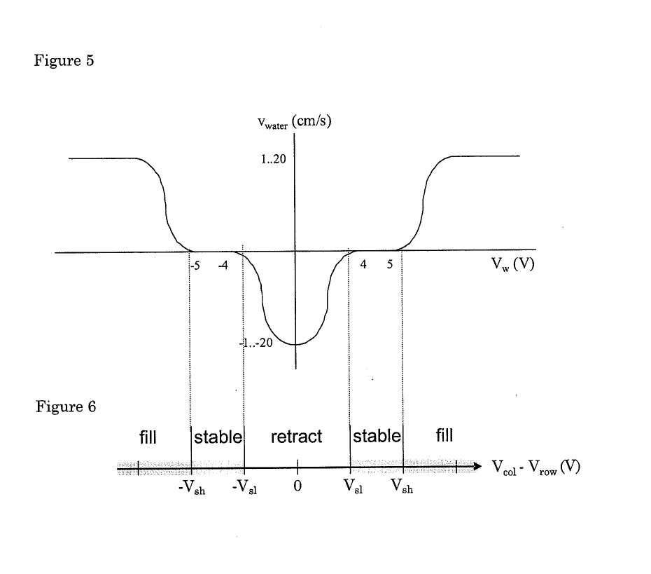

FIG. 5 shows a schematic chart of the water front velocity (v) in the pixel channel as a function of the supply voltage (V). The shown voltage levels and the exact shape of this curve can be influenced by cell geometry and the properties of the applied materials, such as oil viscosity.

The electromechanical force that pulls the water into the channel is proportional to the applied voltage squared. This results in a symmetrical response around 0V (see FIG. 2). Here it is assumed that the top (t) and bottom (b) electrodes are put at the same bias with respect to the water (w) electrode. For a realistic cell, a voltage over the channel of around 4-5V keeps a certain switching state (the “stable” voltage); at a voltage below ˜2V the water retracts into the reservoir (the “retract” voltage) with a negative speed; at a voltage above ˜7V the water advances into the channel (the “fill” voltage) with a positive speed. At higher voltages the speed of the water increases, but saturates at a certain maximum. This effectively gives a response according to the integral of switching speed and time, where the switching speed is proportional to the sum of the voltage squared. The voltages can also be applied asymmetrical between the top and the water and the bottom and the water as long as the sum of the voltages squared is the same. The retraction speed is highest when the water is at the same bias as the top and the bottom electrodes.

The width of the stable region on the x-axis is non-zero due to the effects of wetting hysteresis or a wetting barrier that is inherent to the materials used in the pixel cell, or that is purposely added to define the stable range by modifying the channel wetting property. The effect of these barriers is to locally increase the width of the stable region to lower voltages and to higher voltages, respectively, yielding preferential states of the oil-water distribution in the pixels. These preferential states can be used as discrete gray levels or as an intermediate starting level from which gray levels can be reached faster and more accurate.

These barriers may be provided by physical structures locally influencing an applied electric field to the channel surface having a wetting property, by physical structures locally influencing the wetting property or by physical structures locally influencing the radius of curvature and thus the Young-Laplace pressure of the polar liquid in the channel. These barriers may also include a change in the chemical composition at the surface which has strong influence on the wetting properties.

The speed of the water front typically is in the order of centimeters per second and preferably between 0 and 50 centimeters per second, as 28 centimeters per second yields a switching speed between the black and the white state of about 1 millisecond for a pixel cell size of 0.2 millimeters (having a 0.28 millimeters diagonal size) when the reservoir is positioned in the corner of the pixel cell, which is compatible with displaying video content on the display apparatus. In this simple calculation only the influence of the electromechanical force and the counteracting force have been taken into account; other forces, such as the drag force, that reduce the speed of the water front with the distance of the water front from the reservoir, have not been taken into account.

FIG. 6 shows an abstracted line chart of FIG. 5, assuming the top and bottom electrodes are connected together to the row electrode and the water is connected to the column electrode. As can be seen in this graph, cells can be kept stable by applying a voltage between Vsl and Vsh, which are the lower and upper limits of the stable region irrespective of the sign of the voltage.

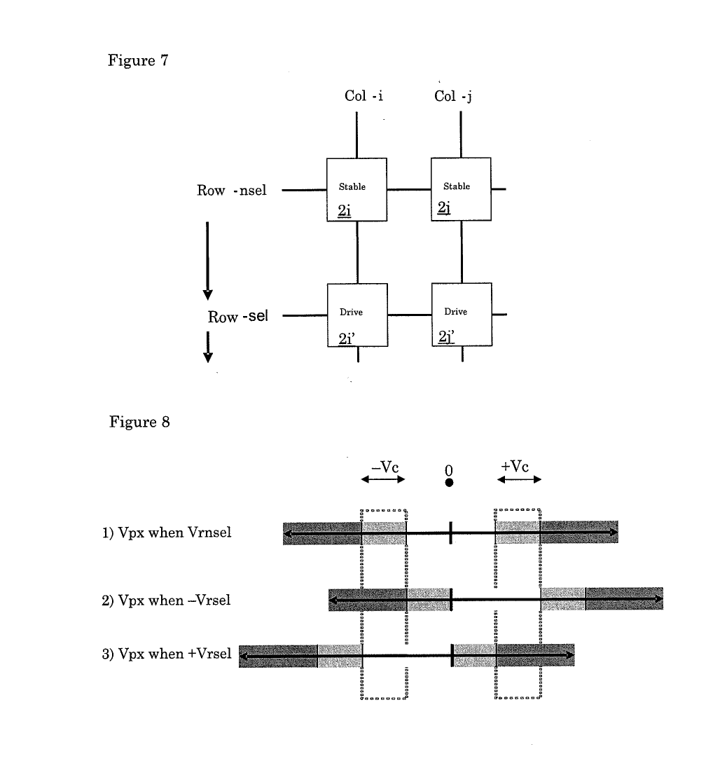

FIG. 7 shows a schematic passive matrix arrangement for a plurality of pixel cells 2. As indicated schematically, a passive-matrix driving arrangement results in one row of pixels 2i′, 2j′ being driven (in the graph indicated as Row—sel), depending on a row select and/or column voltage polarity, in the fill region or in the retract region. In the row select condition it is preferred to also have the supply voltage range in the stable region to provide a stable bordering condition wherein the amount of fluid is kept stable in the channel. The stable condition can typically be provided with the column voltage in its maximum or minimum, depending on voltage polarity but this is not essential. At the same time, non selected pixels 2i, 2j, in other rows (indicated as Row—nsel), in a row non-select condition, receive a pixel supply voltage ranging in the stable region independent of the column voltage.

Accordingly, via row and column electrodes, driver 8 is directly connected to the pixel cell terminals 2i, 2j on a circuit board comprising row and column electrodes each directly connecting the driver 8 to the pixel cell terminals 2i, 2j for supplying the supply voltage Vpx to the pixel cell terminals as a voltage difference Vcol−Vrow between the row and column electrodes in a passive matrix configuration.

To prevent degenerative effects of unipolar electric fields, typically on a row, column or frame basis the row and column polarity may be periodically inverted relative to each other to invert the polarity of the supply voltage, so as to obtain an average supply voltage being essentially zero with no directional build-up of charges in the pixel cells.

FIG. 8 shows a first driving embodiment of a driving method for supplying a supply voltage Vpx as a voltage difference between the row and column electrodes Vcol−Vrow to a pixel cell 2i, j in a passive matrix configuration as shown in FIG. 7, with a possibility of polarity inversion. Three row select voltages are indicated: 1) Vpx when Vrnsel: a non-select row voltage Vrnsel results in a supply voltage Vpx ranging in the stable region between Vsl and Vsh; 2) Vpx when −Vrsel: a row select voltage Vrsel is negative resulting in a fill movement, a retract movement or no movement (a stable position), depending on the column voltage polarity Vc. As can be seen in the graph, a positive column polarity +Vc will provide a supply voltage in the retract or stable regime for row voltages Vrsel; whereas a negative column polarity −Vc will result in a supply voltage in the fill or stable regime. 3) Inversion of the row select voltage to Vrsel can be provided for by using a correspondingly inverted column voltage Vc. Hence for negative column voltages −Vc the supply voltage Vpx ranges in a retract or stable regime and for positive column polarities +Vc the supply voltage Vpx ranges in the fill or stable regime.

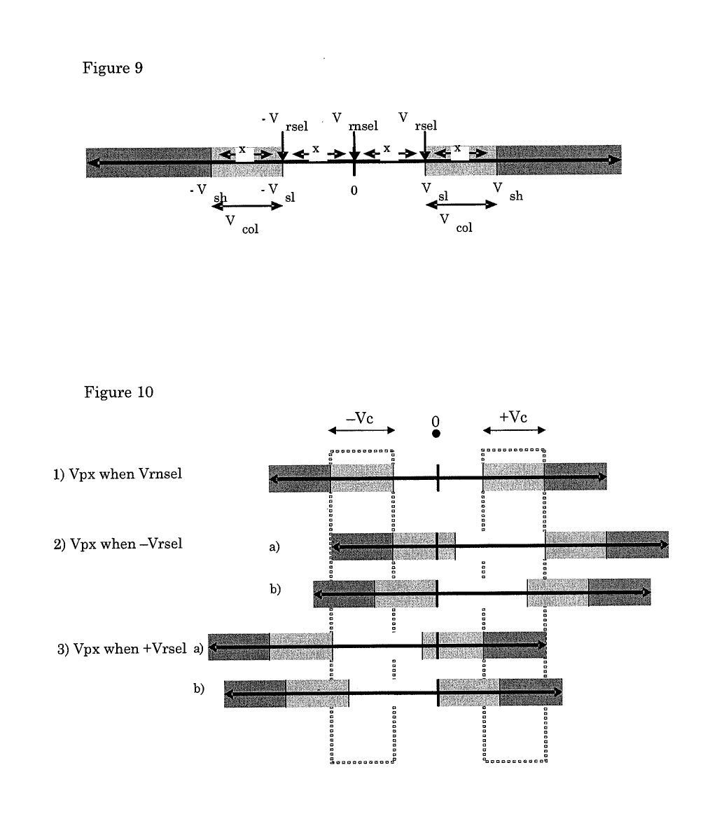

FIG. 9 shows a special case of the first embodiment wherein preferred ratios are indicated between the supplied voltage levels of Vrow and Vcol.

A typical preferred value of the row select voltage Vrsel is about Vsl which typically ranges between 3.5 and 4.5 Volts. A typical preferred value of the row non-select voltage is about 0V, typically ranging between −0.5 and +0.5 V. With a sufficient margin for error it is important that the stable region is sufficiently wide and is centered preferably halfway 0V and the voltage at which fill speed saturation occurs (typically above the 8-9 V). The width of the stable region is a compromise between the allowable signal perturbations, caused e.g. by crosstalk, and needed voltage swings. Advantageously, the stable voltage range has a lower stable voltage and a higher stable voltage differing in a range of 0.5-1.5 V. In practice, the stable voltage region has a width of 1V, centered around 4.5V. Typical voltage swings for such system are in the order of 10V.

Preferably the supply voltage is provided having the width of the stable region at least larger than or equal to the half width of the retract region. This may result in a drive scheme where the pixels of a selected row can either be driven to white or to black or can be kept in their current switching state, while the pixels in the not selected rows are kept in their current switching state. A shift of the voltages Vrow and Vcol is possible when the voltage difference remains the same resulting in unchanged supply voltage Vpx.

FIG. 10 shows a second embodiment of a driving method for a passive matrix. In this embodiment the width of the stable region is larger than half of the width of the retract region. For example, a preferred value of the row select voltage Vrsel is about Vsl which now typically ranges between 3 and 4 Volts. With a wider stable region Vsh may typically range between 5 and 6 Volts. A typical preferred value of the row non-select voltage is about 0V, typically ranging between −0.5 and +0.5 V. As in FIG. 8 again three row select voltage options are indicated: 1) Vrnsel: a non-select row voltage Vrnsel results in a supply voltage Vpx ranging in the stable region between Vsl and Vsh; 2) −Vrsel: a row select voltage Vrsel is negative. As can be seen in the graph, a positive column polarity +Vc will provide a supply voltage in the retract or stable regime for row voltages Vrsel; whereas a negative column polarity −Vc will result in a supply voltage in the fill or stable regime; 3) Inversion of the row select voltage to Vrsel can be provided for by using a correspondingly inverted column voltage Vc. Hence for negative column voltages −Vc the supply voltage Vpx ranges in a retract or stable regime and for positive column polarities +Vc the supply voltage Vpx ranges in the fill or stable regime.

In contrast to the FIG. 8 embodiment, with an increased stable region the options to stabilize the liquid movement during the row select period can be enhanced. For the option 2) with negative row select polarity either a) the row select voltage can be correspondingly increased resulting again in the border of the stable region being just accessible by the column voltage during the select period (i.e. the row select voltage is as large as the width of the stable region, FIG. 10a) or b) the row select voltage can remain at the same value resulting in a larger part of the stable region being accessible during the row select period (i.e. the row select voltage is as large as half the width of the retract region FIG. 10b). As an alternative, (not depicted) a lower row select voltage than the options a-b) is also possible resulting in a corresponding shift to left of the line graph. Thus during the row selection an even larger part of the stable range remains accessible which can be a low power embodiment.

The corresponding alternatives with inverted row polarity are shown in FIG. 10, graph 3) showing a) a line graph with increased row select voltage where the supply voltage includes a stable bordering condition wherein the amount of polar fluid is kept stable in the channel; or b) a row select voltage having the supply voltage partially ranging in the stable region.

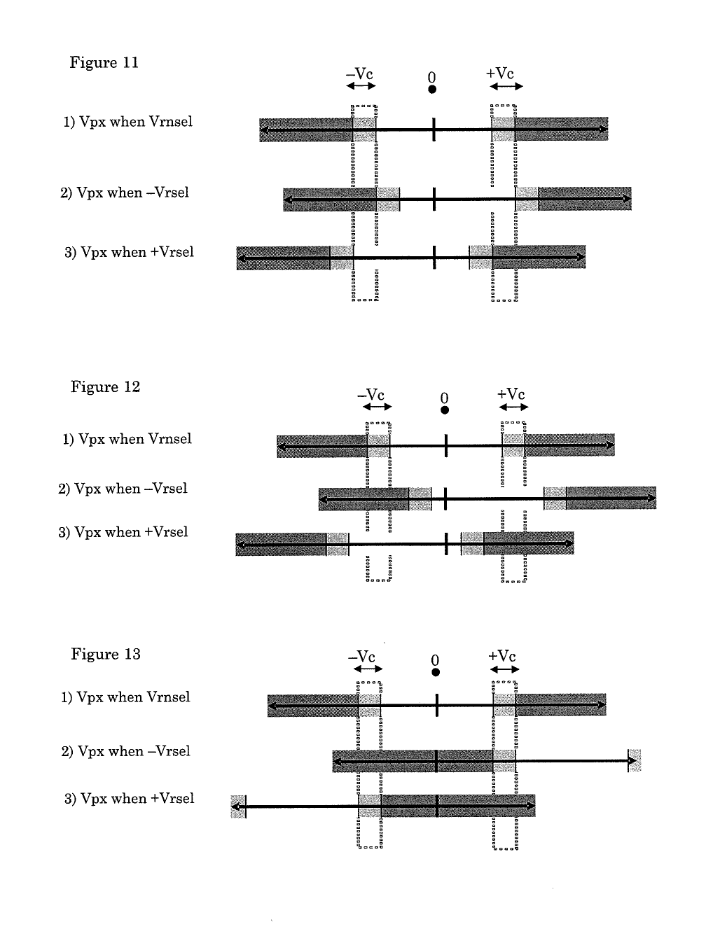

FIG. 11 shows a third embodiment of a driving method for a passive matrix. In this case a passive matrix driving is provided with a stable region width that is smaller than half of the retract region width. Similar to FIG. 9 the row select voltage has an offset compared to the row non-select voltage that is equal to the width of the stable region, i.e. the difference between Vrnsel and +/−Vrsel is equal to the difference between +/−Vsh and +/−Vsl. The effect of the smaller stable region is that it is not possible anymore to use the full range of the retract region and also a smaller part of the fill region is used. This may result in slower switching of the pixels. In the embodiment of FIG. 11 the fill and retract voltage regions include a stable bordering condition wherein the amount of polar fluid is kept stable in the channel.

In contrast, FIG. 12 shows a fourth embodiment of a driving method for a passive matrix. In this embodiment the voltage difference between the row select and the row non-select voltages is increased beyond the width of the stable region. The effect is that larger retract and fill speeds can be obtained.

However, during the row select the fill and retract voltage regions do no longer include a stable bordering condition wherein the amount of polar fluid is kept stable in the channel. Therefore to obtain a stable condition, wherein the pixel cell is kept in a stable state during a row select period, the pixel may be subsequently switched to a fill state and to a retract state with as a net result no change in the switching state. This can for example be provided by pair wise subsequent row select pulses or alternatively with two consecutive row selection periods that are spaced sufficiently close together in time to achieve the same net result.

FIG. 13 shows a special case of the fourth embodiment of a driving method for a passive matrix where the row select voltages are increased to a point where one stable region is again overlapping with the stable region of the rows that are not selected. This creates a situation where during a single row select period either a retract or a fill state in combination with a stable state can be attained depending on the column polarity. A drive scheme wherein both retract and fill conditions are provided can be provided by having two row selection periods spaced close together in time where the row voltage is inverted. This ‘one-sided’ drive scheme is also possible with larger stable regions compared to the size of the retract region.

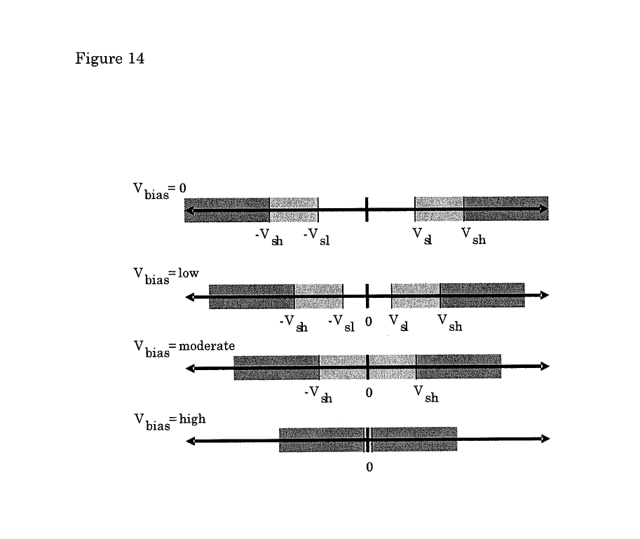

FIG. 14 shows abstracted line charts wherein various bias voltages are applied to the pixel cell, for example, in the terminal configuration of FIG. 4a where a bias voltage different than 0V can be used on the top electrode to bring the system into a biased mode. The effect of this biased mode is that it effectively changes the speed vs. bias diagram for the row and column biases since the application of a bias voltage will reduce the retract region centered around zero Volts, to a point that no retract is possible and or the stable region is substantially reduced (lowest graph).

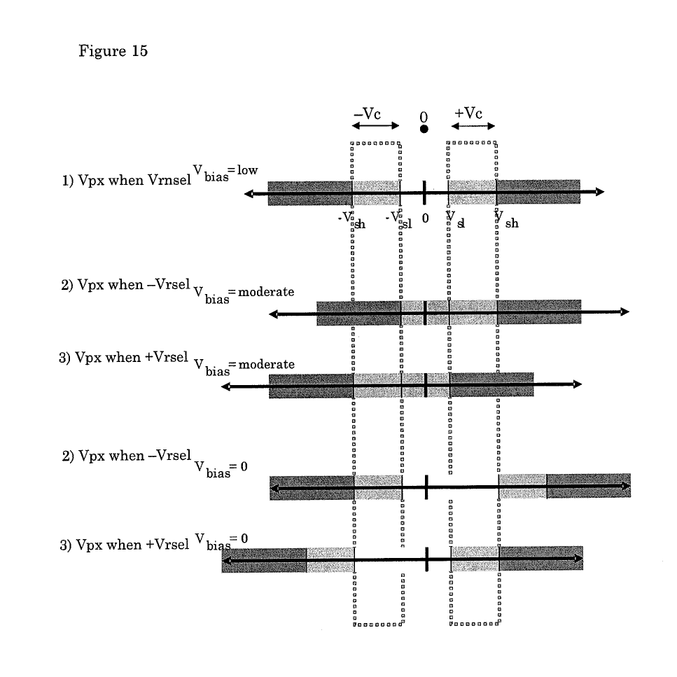

As indicated in FIG. 15 an additional bias voltage with the above described effect can be applied in various forms and configurations. A fifth embodiment is shown of a driving method for a passive matrix including a bias voltage for a 3-electrode configuration of for example FIG. 4(a). The combination of row, column and bias voltages can result in a lower voltage multiphase drive scheme: in a first phase a first selection period is active with a supply voltage in the retract/stable range, followed by a second selection period in a second phase with a supply voltage in the fill/stable range. The additional advantage is that during each selection period the column voltage can be set to the fill or retract voltage respectively as long as needed, followed by a reset of the column voltage to the stable voltage. This makes accurate switching at high switching speed possible. Other low voltage drive schemes can also be created, such as a first period where retract/stable/fill is possible, followed by a second period where only fill/stable is possible.

FIG. 16 shows a sixth embodiment of a driving method for a passive matrix including a bias voltage supplied via an additional bias electrode. In this embodiment a pixel is designed to have a smaller stable region width compared to the retract region width, similar to the embodiment of FIG. 13 where a stable region is again overlapping with the stable region of the rows that are not selected. During a single row select period either a retract or a fill state can be attained depending on the column polarity; where the alternative polarity results in a stable pixel.

The cell display property may be expressed as the transmission and/or reflection of the pixel cell at a predefined wavelength or in a range of predefined wavelengths; corresponding to a polar fluid front position in the channel.

Typically, the cell display property is expressed as the transmission and/or reflection of the pixel cell at a predefined wavelength or in a range of predefined wavelengths. The number of cell display properties is generally limited to a number of discrete levels within the complete range of possible transmission and/or reflection values. The pre-defined, discrete transmission and/or reflection values are measurable, physical values that can be represented by a (binary) number and as such can be processed by the controller.

Inversion may in principle be applied to individual pixels or a group of pixels.

Driving can be distributed over more than one frame, thereby lowering the needed voltage swing and also rendering a low-contrast image fast, after which its contrast is improved in one or more subsequent frames.

Pixels can be made multi-stable, enabling removal of all electrode voltages after writing an image without having the water in all pixels retract into the reservoirs.

While the invention has been illustrated and described in detail in the drawings and foregoing description, such illustration and description are to be considered illustrative or exemplary and not restrictive; the invention is not limited to the disclosed embodiments. In particular, unless clear from context, aspects of various embodiments that are treated in various embodiments separately discussed are deemed disclosed in any combination variation of relevance and physically possible and the scope of the invention extends to such combinations. In the embodiments the column voltage range is restricted to a small band defined by the stable region at Vrow=Vrnsel so that rows that are not selected are only driven within the stable voltage range. In the embodiments, row electrodes are substantially similar in structure in respect of the column electrodes and can be interchanged with the column electrodes—that is a supply voltage to the pixel can be provided with a ‘column’ electrode having a column select voltage, whereas the row electrode is then provided with a corresponding row voltage for providing the supply voltage. Such and other variations to the disclosed embodiments can be understood and by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

What is claimed is:

1. A display apparatus comprising:
a plurality of electrofluidic chromatophore (EFC) pixel cells, each pixel cell comprising:
a fluid holder for holding a polar fluid and a non-polar fluid having differing display properties, the fluid holder comprising
a reservoir with a geometry having a small visible area projected in the direction of a viewer, and
a channel with a geometry having a large visible area projected in the direction of a viewer, the channel being connected to the reservoir so as to enable free movement of the polar fluid and non-polar fluid between the channel and the reservoir, at least part of a surface of the channel comprising a wetting property responsive to a supply voltage over the pixel cell and defining (i) a stable region wherein the supply voltage stabilizes the amount of polar fluid in the channel; (ii) a fill region that controls the flow of polar fluid into the channel and (iii) a retract region that controls the flow of polar fluid into the reservoir;
at least two pixel cell terminals being configured to supply the supply voltage to at least part of the surface of the fluid holder comprising the wetting property for supply voltage controlled movement of polar fluid; the display further comprising
a driver operative to provide controlled column voltages and any of a predefined row select or non-select voltage via respective column and row electrodes; and
a circuit board comprising the row and column electrodes each directly connecting the driver to the pixel cell terminals for supplying the supply voltage to the pixel cell terminals as a voltage difference between the row and column electrodes in a passive matrix configuration.

2. The display apparatus according to claim 1, wherein the driver is configured to provide a row select condition, and a row non-select condition, wherein, in the row select condition, depending on a column voltage polarity, the supply voltage at least ranges in the fill or the retract region; and wherein the column voltage range is chosen such that in the row non-select condition the supply voltage only ranges in the stable region.

3. The display apparatus according to claim 2, wherein the driver is configured to provide, in the row select condition, the supply voltage ranging in the stable region to provide a stable condition.

4. The display apparatus according to claim 1, wherein a further pixel cell terminal is electrically connected to a further electrode directly connected to the driver to provide a bias supply voltage.

5. The display apparatus according to claim 4, wherein the further electrode is a common terminal connected to an electrode that is common for all or a group of pixel cells in the display.

6. The display apparatus according to claim 1, wherein the wetting property defines a stable voltage range having a lower stable voltage and a higher stable voltage differing in a range of 0.5-2.5 V.

7. The display apparatus according to claim 1, wherein the wetting property defines a width of the stable region that is at least larger or equal to half the width of the retract region.

8. The display apparatus according to claim 1, wherein the channel comprises wetting barriers.

9. The display apparatus according to claim 1, wherein the driver is configured to periodically invert the row and column polarities relative to each other to invert the polarity of the supply voltage, so as to obtain an average supply voltage being essentially zero with no directional build-up of charges in the pixel cells.

10. The display apparatus according to claim 1, wherein the wetting property is expressed as a rate of change in the transmission and/or reflection of the pixel cell for a predefined wavelength.

11. The display apparatus according to claim 1, wherein the polar fluid is conductive, wherein the row electrode is coupled to a contact electrode contacting the conductive polar fluid.

12. The display apparatus according to claim 1, wherein the polar fluid is conductive and wherein the row electrode is coupled to a channel electrode

13. The display apparatus according to claim 1, wherein the polar fluid is conductive and the column voltage terminal is coupled only to a channel electrode on a side facing away from a direction of the viewer.

14. A method of driving a display apparatus comprising a plurality of electrofluidic chromatophore (EFC) pixel cells, each pixel cell comprising a fluid holder for holding a polar fluid and a non-polar fluid having differing display properties, the fluid holder comprising a reservoir with a geometry having a small visible area projected in the direction of a viewer onto the polar fluid, and a channel with a geometry having a large visible area projected in the direction of a viewer onto the polar fluid, the channel being connected to the reservoir so as to enable free movement of the polar fluid and non-polar fluid between the channel and the reservoir, at least part of a surface of the channel comprising a wetting property responsive to a supply voltage over the pixel cell and defining (i) a stable region wherein the supply voltage stabilizes the amount of polar fluid in the channel; (ii) a fill region that controls the flow of polar fluid into the channel and (iii) a retract region that controls the flow of polar fluid into the reservoir; wherein at least two pixel cell terminals are configured to supply the supply voltage to at least part of the surface of the channel comprising the wetting property for supply voltage controlled movement of polar fluid; comprising
providing controlled column voltages and any of a predefined row select or non-select voltage via a circuit board comprising respective row and column electrodes each directly connecting the driver to the pixel cell terminals for supplying the supply voltage to the pixel cell terminals as a voltage difference between the row and column electrodes in a passive matrix configuration.

15. The method according to claim 14 wherein, in a row select condition, depending on a row select and/or column voltage polarity, the supply voltage at least ranges in the fill or the retract region; and wherein the column voltage range is chosen such that in a row non-select condition, the supply voltage only ranges in the stable region.
